(19) United States
(12) Patent Application Publication
(10) Pub. No.: US 2026/0340792 A1
(43) Pub. Date: Oct. 29, 2026

(54) MULTI-LEVEL ENCODERS FOR IMAGE RESTORATION AND SUPERSAMPLING

(71) Applicant: ADOBE INC., SAN JOSE, CA (US)

(72) Inventors: Haitian Zheng, San Jose, CA (US); Yongsheng Yu, Rochester, NY (US); Zhifei Zhang, San Jose, CA (US); Zhe Lin, Clyde Hill, WA (US); Connelly Stuart Barnes, Bellevue, WA (US); Jianming Zhang, Cupertino, CA (US); Yuqian Zhou, Redmond, WA (US); Yuchen Liu, San Jose, CA (US)

(21) Appl. No.: 19/190,281

(22) Filed: Apr. 25, 2025

(51) Int. Cl. G06T 5/80; G06T 3/40; G06T 5/60; G06T 5/70

(52) U.S. Cl. CPC G06T 5/80; G06T 3/40; G06T 5/60; G06T 5/70; G06T 2207/20084

(57) ABSTRACT

A method, apparatus, non-transitory computer readable medium, and system for restoring degraded images and supersampling low resolution images includes obtaining an input image containing degradation artifacts. The system downsamples the input image to obtain a downsampled image and encodes the input image using an image generation model to extract latent image features. The image generation model then generates a restored image based on both the downsampled image and the latent image features. The restored image removes the degradation artifacts from the input image.

### BACKGROUND

The following relates generally to image processing, and more specifically to image restoration. Image processing is a type of data processing that involves the manipulation of an image to get the desired output, typically utilizing specialized algorithms and techniques. It is a method used to perform operations on an image to enhance its quality or to extract useful information from it. This process usually comprises a series of steps that includes the importation of the image, its analysis, manipulation to enhance features or remove noise, and the eventual output of the enhanced image or salient information it contains.

Image restoration is a field within image processing that focuses on recovering or enhancing degraded images. Common restoration tasks include removing noise, correcting color fading, repairing scratches or tears, sharpening blurred regions, and eliminating compression artifacts. Traditional restoration approaches use mathematical models that characterize the degradation process and apply inverse operations to recover the original image. Recent advances have incorporated machine learning and generative models to extrapolate and infer missing details from degraded images. Such approaches can predict missing details by learning patterns from large datasets of similar images. However, in some cases, generative models can produce inaccurate or implausible details when the degradation is severe or when the model encounters unfamiliar image content. Furthermore, such models may require several minutes or longer to restore a single image.

### SUMMARY

Embodiments of the present disclosure include systems and methods for processing images, and in particular for restoring degraded images and upsampling low resolution images with improved quality and increased inference speed. Embodiments include a multi-level encoder which generates latent representations of an input image (e.g., an image with a degradation) from the perspective of multiple resolutions. A fine-level encoder generates latent image features from the full-resolution input image, a coarse-level encoder generates latent image features from a downscaled version of the input image, and the system further incorporates a highly downsampled version of the input as a macro-level representation. These various image features are combined into a multi-level input in a compressed latent space. According to some aspects, the multi-level encoder generates a latent tensor with highly compressed spatial dimensions, for example, a 32× reduction. This greatly speeds up the inference process, which utilizes a denoising model whose speed is a factor of the spatial dimensions of its input conditions. Some embodiments include a pixel-aware decoder that decodes token representations of the latent maps to generate the restored image, and which further leverages details from the non-encoded input during the generation.

A method, apparatus, non-transitory computer readable medium, and system for image restoration are described. One or more aspects of the method, apparatus, non-transitory computer readable medium, and system include obtaining an input image including a degradation artifact; downsampling the input image to obtain a downsampled image; encoding, using an image generation model, the input image to obtain latent image features; and generating, using the image generation model, a restored image based on the downsampled image and the latent image features wherein the restored image removes the degradation artifact from the input image.

A method, apparatus, non-transitory computer readable medium, and system for image restoration are described. One or more aspects of the method, apparatus, non-transitory computer readable medium, and system include obtaining an input image; downsampling the input image to obtain an intermediate image having a resolution less than the input image; downsampling the input image to obtain a downsampled image having a resolution less than the intermediate image; and generating, using an image generation model, a restored image based on the input image, the intermediate image, and the downsampled image.

An apparatus, system, and method for image restoration are described. One or more aspects of the apparatus, system, and method include a memory component; a processing device coupled to the memory component, the processing device configured to perform operations comprising; obtaining a low quality image for image restoration; downsampling the low quality image to obtain a downsampled image in pixel space; encoding the low quality image to obtain a latent map in a latent space; and generating, using an image generation model, a restored image based on the low quality image, the downsampled image, and the latent map.

### BRIEF DESCRIPTION OF THE DRAWINGS

FIG. 1 shows an example of an image processing system according to aspects of the present disclosure.

FIG. 2 shows an example of an image processing apparatus according to aspects of the present disclosure.

FIG. 3 shows an example of a Transformer architecture according to aspects of the present disclosure.

FIG. 4 shows an example of a guided latent diffusion model according to aspects of the present disclosure.

FIG. 5 shows an example of a U-Net architecture according to aspects of the present disclosure.

FIG. 6 shows an example of a diffusion transformer (DiT) architecture according to aspects of the present disclosure.

FIG. 7 shows an example of a multi-level encoder according to aspects of the present disclosure.

FIG. 8 shows an example of a decoder according to aspects of the present disclosure.

FIG. 9 shows an example of an inference pipeline according to aspects of the present disclosure.

FIG. 10 shows an example of a method for generating a restored image according to aspects of the present disclosure.

FIG. 11 shows an example of a training pipeline according to aspects of the present disclosure.

FIG. 12 shows an example of a step-by-step algorithm for training machine learning (ML) models according to aspects of the present disclosure.

FIG. 13 shows an example of a method for training a diffusion model according to aspects of the present disclosure.

FIG. 14 shows an example of a computing device according to aspects of the present disclosure.

### DETAILED DESCRIPTION

Image processing techniques, such as image generation, are frequently used in creative workflows. Historically, users would rely on manual techniques and drawing software to create visual content. The advent of machine learning (M L) has enabled new workflows that automate the image creation process. These M L-based workflows can significantly reduce the time and technical expertise required to produce complex visual content, allowing creators to focus more on ideation and less on manual execution.

ML is a field of data processing that focuses on building algorithms capable of learning from and making predictions or decisions based on data. It includes a variety of techniques, ranging from simple linear regression to complex neural networks, and plays a significant role in automating and optimizing tasks that would otherwise require extensive human intervention.

Image restoration is an application of image processing that focuses on recovering degraded images. Traditional image restoration methods address specific types of degradation through targeted techniques. Denoising algorithms remove unwanted noise patterns by distinguishing between signal and noise components. Deblurring techniques restore sharpness to images affected by motion blur, defocus, or atmospheric distortion. Color correction methods adjust faded or discolored images by rebalancing color channels and enhancing contrast. These techniques use mathematical models that characterize the degradation process and apply inverse operations to recover the original image content.

Image restoration may involve balancing multiple competing goals. Aggressive restoration can introduce new artifacts while attempting to remove existing ones. For example, strong denoising may remove fine texture details along with noise, and aggressive sharpening can create ringing artifacts around edges. Traditional approaches use regularization techniques to control this trade-off, such as imposing constraints that preserve image structures while reducing degradation. Different applications prioritize different aspects of this balance. Medical imaging may prioritize preserving diagnostic details, while consumer photography might emphasize visually pleasing results even at the cost of some accuracy. A s computational power has increased, restoration techniques have evolved from simple filters to sophisticated algorithms that adapt to image content and degradation types.

These restoration techniques also apply to image supersampling, where a low-resolution image is upscaled to a higher resolution. In this context, the inherent blurriness of the upscaled image can be considered a form of degradation. The supersampling process aims to generate missing high-frequency details that were lost in the original low-resolution representation. This application of restoration techniques enables the enhancement of image quality beyond the details of the original capture resolution, with applications in fields ranging from digital photography to medical imaging and satellite imagery analysis.

Conventional image restoration approaches address specific degradation types using specialized architectures. Some methods use deep convolutional networks to target isolated problems like noise removal or blur correction, but struggle with complex real-world degradations that combine multiple issues. Other approaches attempt to create unified models for handling diverse degradation types simultaneously. While these methods show improved flexibility, they frequently face challenges with detail preservation, particularly at high resolutions or extreme scaling factors.

Some conventional systems use generative techniques that can produce visually pleasing results but compromise accuracy in reconstructing fine details. These approaches can introduce hallucinated features that appear plausible but deviate from the original content. Furthermore, architectural limitations in many conventional systems create practical constraints for deployment. For example, conventional model architectures may require prohibitively large amounts of memory to deploy the model at inference. Further, such architectures can lead to slow inference speeds, especially when processing higher-resolution images. Additionally, memory limitations and training limitations can prevent these models from encoding sufficient contextual information, resulting in inconsistent restorations across different image regions.

The present embodiments improve both the inference speed and the accuracy (e.g., fidelity to the inputs) of image restoration systems. The image processing system includes a multi-level encoder that generates latent features from different scales of the input image in a highly spatially compressed latent space. These features capture a wide breadth of image characteristics from the input and enable a denoising model to accurately infer missing details from degradations in the original input, while operating more efficiently in the compressed space. Some embodiments further include a decoder configured to generate the restored image from the latent features, where the decoder incorporates the input image directly via skip connections from a feature extractor model. Accordingly, embodiments are configured to restore degraded images using both the generated multi-scale latent features as well as directly from the input image.

As used herein, a “degradation artifact” refers to an undesirable visual characteristic of an image that can reduce the resolvable details of the image. Examples of degradation artifacts include blurred or noisy portions of an image, or artifacts caused by compression techniques such as JPEG compression. A “restored image” is an image that depicts the elements from an input image with the degradation artifact(s) removed. In some cases, embodiments are used for an upsampling task, in which a low resolution image is first upscaled to a higher resolution, thereby introducing blurriness. In these cases, the blurriness caused by upscaling is considered to be the degradation artifact. Embodiments remove this blurriness through generative processes, “upsampling” the image.

An “image generation model” as described herein includes a multi-level encoder, a denoising model, and a decoder. The multi-level encoder generates latent image features from different scales of an input image. The denoising model is a generative model configured to process the latent image features to infer new details in the latent space. For example, the denoising model may obtain noise samples as a “canvas” for image generation, and denoise the noise samples based on the latent image features to obtained denoised features in the latent space. The decoder processes the denoised features to obtain a pixel image the restored image.

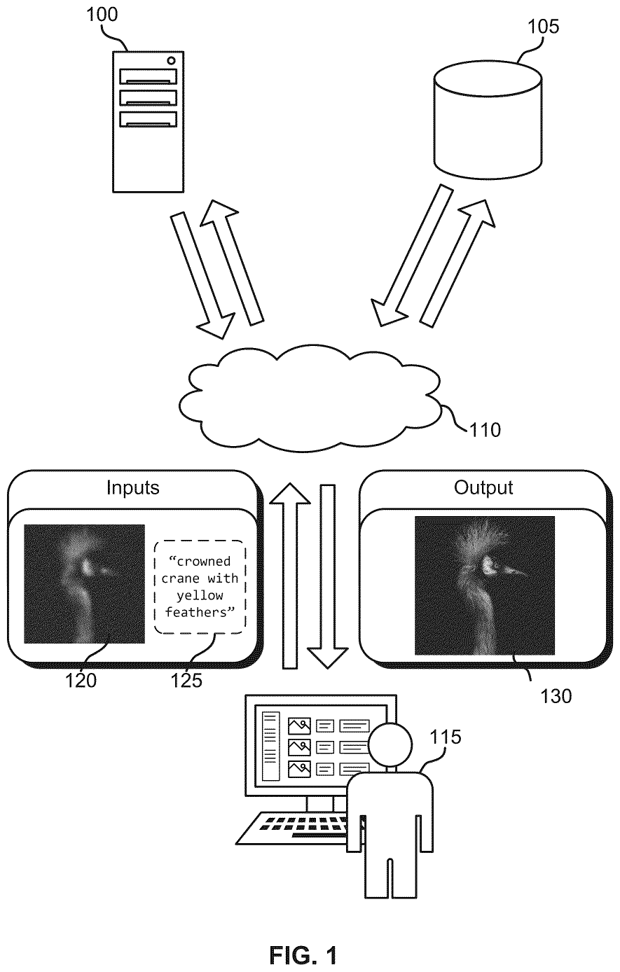

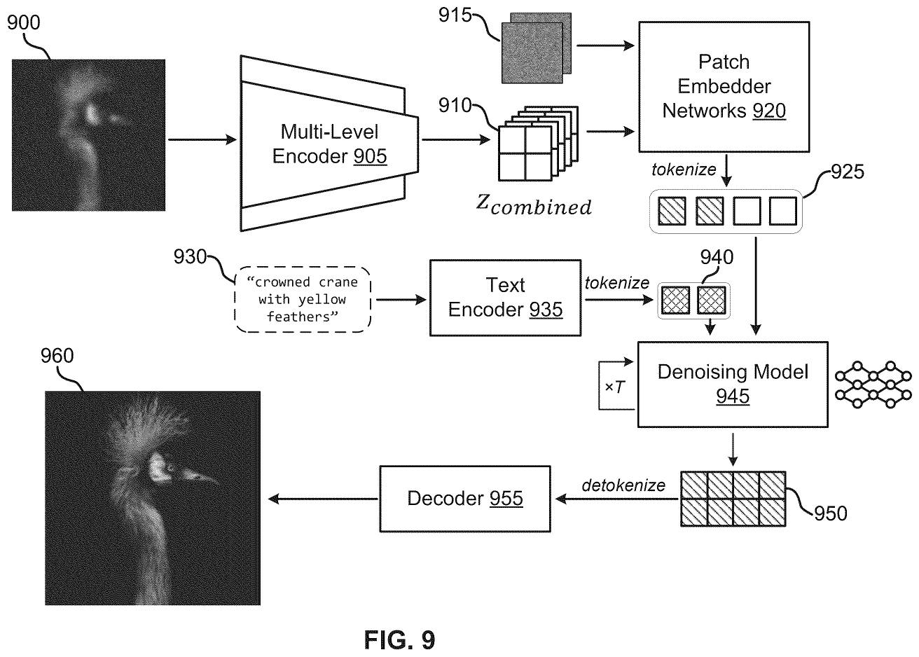

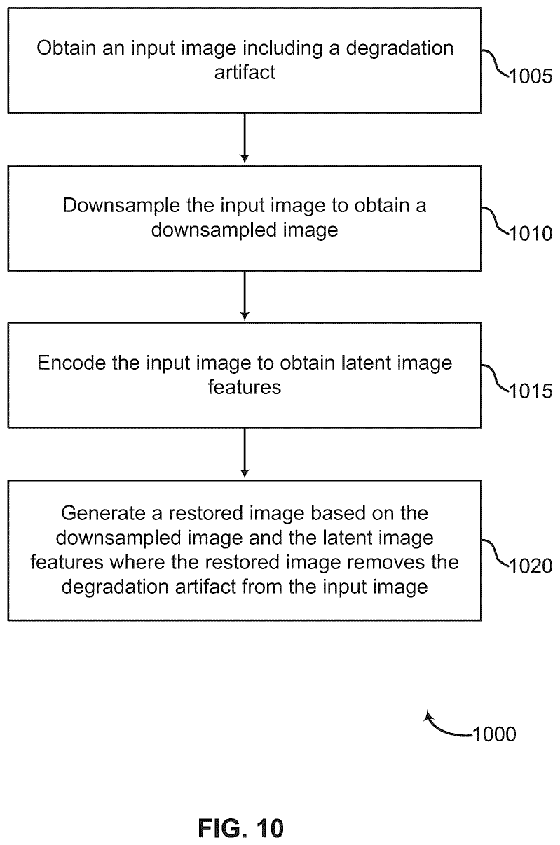

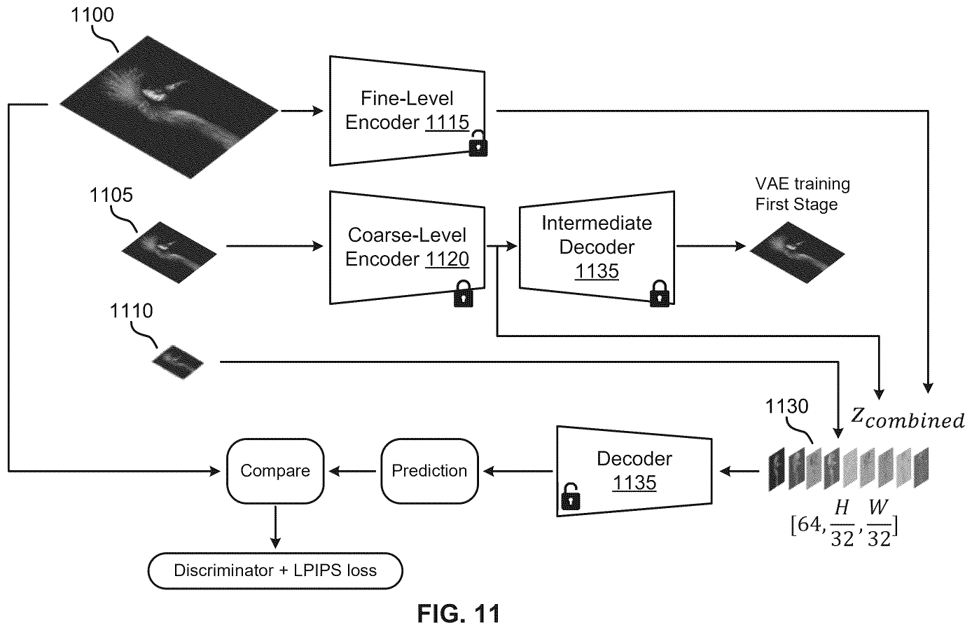

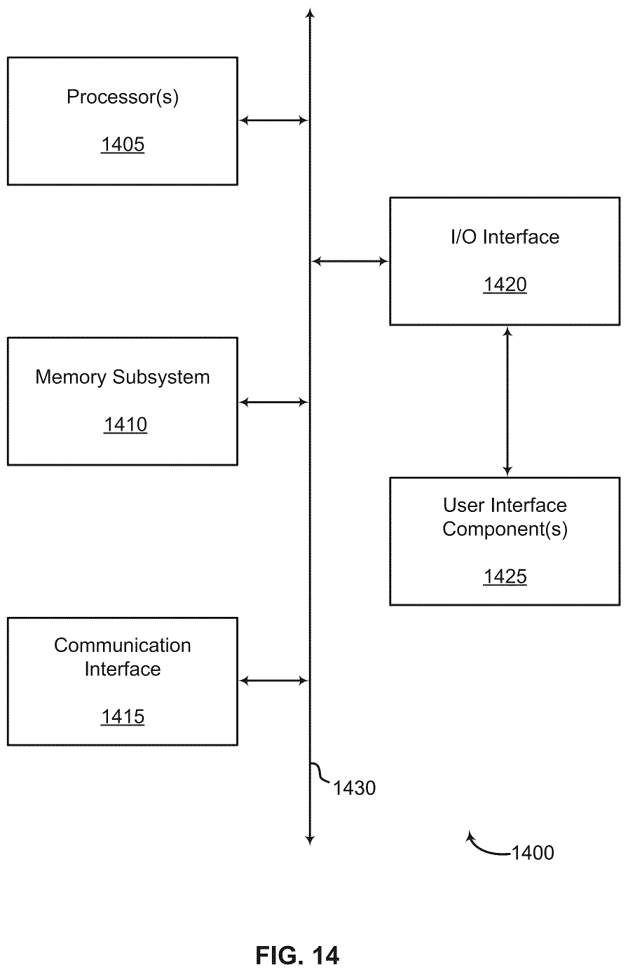

An image processing system is described with reference to FIGS. 1-8. A pipeline and method for image restoration are described with reference to FIGS. 9-10. Training methods are described with reference to FIGS. 11-13. A computing device configurable to implement an image processing apparatus is described with reference to FIG. 14.

### Image Processing System

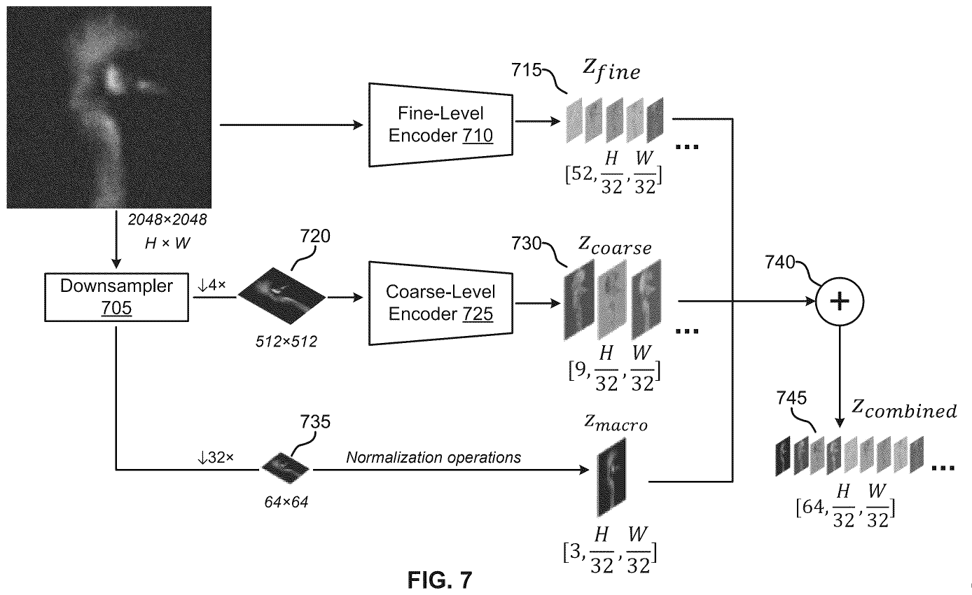

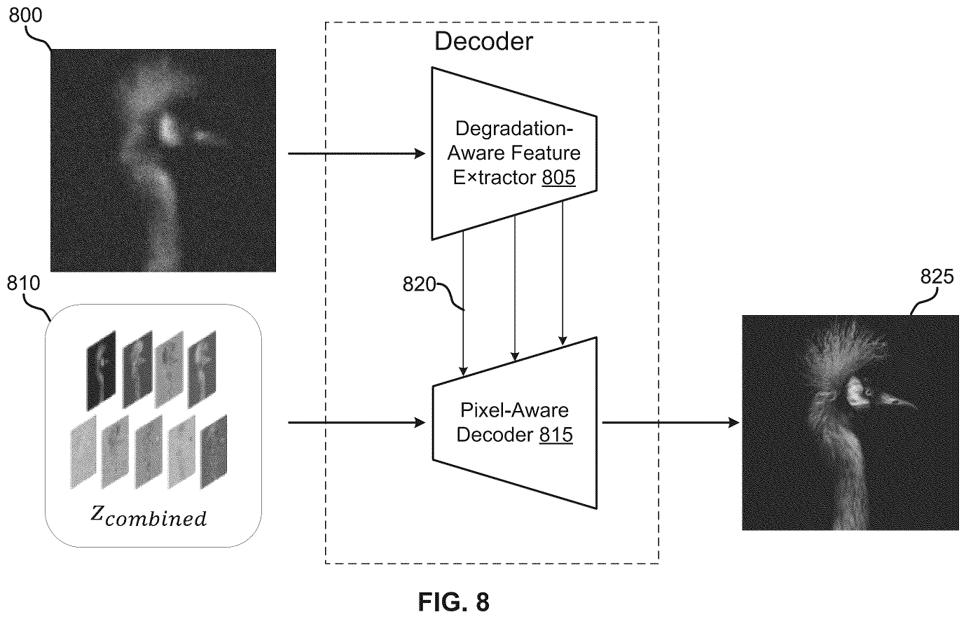

FIG. 1 shows an example of an image processing system according to aspects of the present disclosure. The example shown includes image processing apparatus 100, database 105, network 110, user 115, degraded image 120, guidance prompt 125, and restored image 130. Degraded image 120 is an example of, or includes aspects of, the corresponding element described with reference to FIGS. 7-9. Restored image 130 is an example of, or includes aspects of, the corresponding element described with reference to FIGS. 8 and 9.

In an example process, user 115 provides inputs including degraded image 120 and (optionally) guidance prompt 125. Degraded image 120 includes a degradation artifact such as blurriness, noise, color banding, or another undesirable characteristic that user 115 wishes to be removed. Guidance prompt 125 is, for example, a text prompt that describes the contents of degraded image 120. Then, image processing apparatus 100 processes the inputs to generate restored image 130 which is provided to user 115.

In some embodiments, one or more components of image processing apparatus 100 are implemented on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SM TP), although other protocols such as file transfer protocol (FTP), and simple network management protocol (SN M P) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a super computer, or any other suitable processing apparatus.

Database 105 is configured to store information used by the image processing system. For example, database 105 may store model parameters, generated images, generated videos, intermediate representations and embeddings, user configuration settings, activity history, model training data, and the like. A database is an organized collection of data. For example, a database stores data in a specified format known as a schema. A database may be structured as a single database, a distributed database, multiple distributed databases, or an emergency backup database. In some cases, a database controller may manage data storage and processing in a database. In some cases, a user interacts with the database controller. In other cases, the database controller may operate automatically without user interaction.

Network 110 facilitates the transfer of information between image processing apparatus 100, database 105, and user 115. In some cases, network 110 is referred to as a “cloud.” A cloud is a computer network configured to provide on-demand availability of computer system resources, such as data storage and computing power. In some examples, the cloud provides resources without active management by the user. The term cloud is sometimes used to describe data centers available to many users over the Internet. Some large cloud networks have functions distributed over multiple locations from central servers. A server is designated an edge server if it has a direct or close connection to a user. In some cases, a cloud is limited to a single organization. In other examples, the cloud is available to many organizations. In one example, a cloud includes a multi-layer communications network comprising multiple edge routers and core routers. In another example, a cloud is based on a local collection of switches in a single physical location.

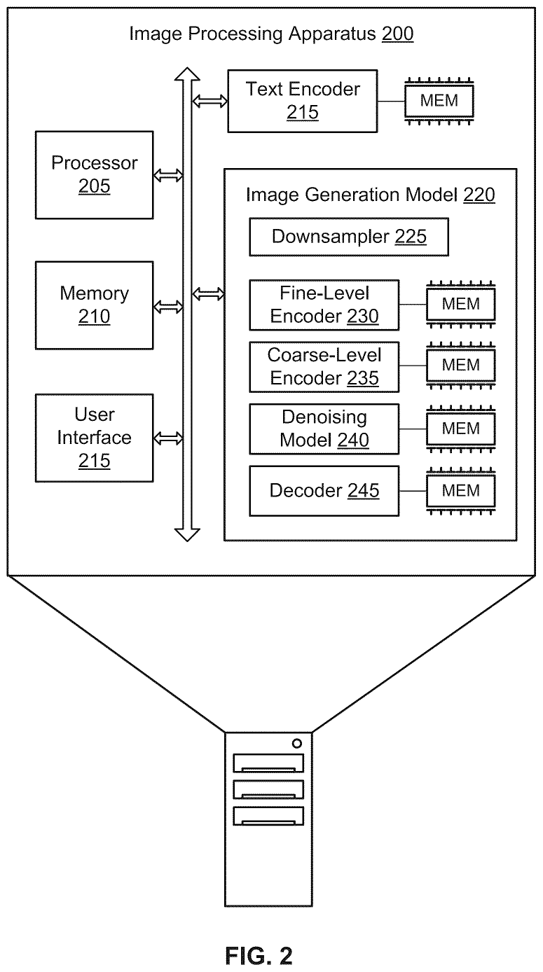

FIG. 2 shows an example of an image processing apparatus 200 according to aspects of the present disclosure. The example shown includes image processing apparatus 200, processor 205, memory 210, user interface 215, text encoder 220, and image generation model 225.

Image processing apparatus 200 is an example of, or includes aspects of, the corresponding element described with reference to FIG. 1. Text encoder 220 is an example of, or includes aspects of, the corresponding element described with reference to FIG. 9. Downsampler 230 is an example of, or includes aspects of, the corresponding element described with reference to FIG. 7. Fine-level encoder 235 is an example of, or includes aspects of, the corresponding element described with reference to FIGS. 7 and 11. Coarse-level encoder 240 is an example of, or includes aspects of, the corresponding element described with reference to FIGS. 7 and 11. Denoising model 245 is an example of, or includes aspects of, the corresponding element described with reference to FIG. 9. Decoder 250 is an example of, or includes aspects of, the corresponding element described with reference to FIGS. 9 and 11.

A processor 205 is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, processor 205 is configured to operate a memory array using a memory controller.

In other cases, a memory controller is integrated into processor 205. In some cases, processor 205 is configured to execute computer-readable instructions stored in memory 210 to perform various functions. In some embodiments, processor 205 includes special purpose components for modem processing, baseband processing, digital signal processing, or transmission processing.

Memory 210 stores information used in the operation of image processing apparatus 200. Examples of a memory device include random access memory (RAM), read-only memory (ROM), or a hard disk. Examples of memory devices include solid state memory and hard disk drives. In some examples, memory 210 is used to store computer-readable, computer-executable software including instructions that, when executed, cause processor 205 to perform various functions described herein. In some cases, the memory 210 contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within memory 210 store information in the form of a logical state.

According to some aspects, some components of the image processing apparatus 200 may include dedicated memories as indicated by the ‘MEM’ elements in FIG. 2. These dedicated memories may store model parameters that, when combined with mathematical operations executed by processor 205, cause the corresponding components to perform the functions described herein. In some embodiments, the dedicated memories are implemented as non-transitory computer-readable mediums. The parameters may be stored statically or configured at runtime. For example, adjustments to the parameters may be made during pretraining processes, finetuning processes, or user-configuration processes such as hot-swapping different models. In certain implementations, these specialized memory structures enable hardware-accelerated execution of complex computational functions through purpose-built circuitry optimized for specific operations, thereby transforming the general-purpose computing device into a specialized machine uniquely configured to perform the particular image processing operations described herein. The dedicated memories may be coupled with specialized processing units, such as tensor processing units or neural processing units, which implement custom data paths specifically designed to execute the mathematical operations required by the image processing components.

A user interface 215 enables a user to interact with image processing apparatus 200. In some embodiments, user interface 215 includes an audio device, such as an external speaker system, an external display device such as a display screen, or an input device (e.g., remote control device interfaced with the user interface 215 directly or through an IO controller module). In some cases, user interface 215 includes a graphical user interface (GUI).

Text encoder 220 is configured to process an input text to generate a text embedding. According to some aspects, text encoder 220 utilizes attention operations to adjust initial embeddings from a text prompt to be contextually aware of all of the words in the text prompt. Embodiments of text encoder 220 include a Transformer-based encoder, such as T5, GPT-2, GPT-3, the CLIP text encoder, and the like.

A transformer or transformer network is a type of neural network model used for natural language processing tasks. A transformer network transforms one sequence into another sequence using an encoder and a decoder. Encoder and decoder include modules that can be stacked on top of each other multiple times. The modules comprise multi-head attention and feed forward layers. The inputs and outputs (target sentences) are first embedded into an n-dimensional space. Positional encoding of the different words (i.e., give every word/part in a sequence a relative position since the sequence depends on the order of its elements) are added to the embedded representation (n-dimensional vector) of each word. In some examples, a transformer network includes attention mechanism, where the attention looks at an input sequence and decides at each step which other parts of the sequence are important. The attention mechanism involves query, keys, and values denoted by Q, K, and V, respectively. Q is a matrix that contains the query (vector representation of one word in the sequence), K are all the keys (vector representations of all the words in the sequence) and V are the values, which are again the vector representations of all the words in the sequence. For the encoder and decoder, multi-head attention modules, V consists of the same word sequence than Q. However, for the attention module that is taking into account the encoder and the decoder sequences, V is different from the sequence represented by Q. In some cases, values in V are multiplied and summed with some attention-weights a. This technology may be used to process text as well as other modalities, such as image features. For example, a diffusion transformer (DiT) uses a transformer backbone to perform a generative denoising task.

Image generation model 225 is configured to generate a restored image from an input degraded image. Embodiments of image generation model 225 include, for example, multiple encoders, a generative denoising model, and a decoder configured to map from a latent space into a pixel space. For example, in one aspect, image generation model 225 includes downsampler 230, fine-level encoder 235, coarse-level encoder 240, denoising model 245, and decoder 250.

Downsampler 230 receives an input image and reduces its resolution. For example, downsampler 230 may reduce resolution using bicubic interpolation, area averaging, or convolutional operations with stride. In one example, downsampler 230 processes an input image to obtain a downsampled image

$${I}_{↓ 32} ∈ {ℝ}^{3 \times \frac{W}{32} \times \frac{H}{32}}$$

which is compressed 32× in its spatial dimensions with respect to the input image. In some embodiments, this downsampled image is further processed by normalizing the image using a mean u and a standard deviation σ obtained from a training dataset, e.g.,

$${z}_{macro} = \frac{{I}_{↓ 32} - μ}{σ} .$$

Fine-level encoder 235 generates latent image features from an input image. According to some aspects, fine-level encoder 235 operates on the full-resolution version of an input image without any downsampling. In one embodiment, fine-level encoder 235 processes an input image I∈ [symbol] to generate a 52-channel latent

$${z}_{fine} ∈ {ℝ}^{52 \times \frac{W}{f} \times \frac{H}{f}}$$

where f is a compression ratio, and is, for example, 32. Additional details regarding an example of a fine-level encoder are provided with reference to FIG. 7.

Coarse-level encoder 240 generates latent image features from an input image. According to some aspects, coarse-level encoder 240 operates on a reduced-resolution version of an input image, e.g., as obtained from downsampler 230. In one embodiment, coarse-level encoder 240 processes a reduced resolution (e.g., quarter resolution) input image

$${I}_{↓ 4} ∈ {ℝ}^{3 \times \frac{W}{4} \times \frac{H}{4}}$$

to generate a 9-channel latent

$${z}_{coarse} ∈ {ℝ}^{9 \times \frac{W}{f} \times \frac{H}{f}} .$$

Additional details regarding an example of a fine-level encoder are provided with reference to FIG. 7. According to some aspects, Z_{macro}, Z_{coarse}, and Z_{fine} are concatenated to form a multi-level input, e.g.,

$${z}_{combined} ∈ {ℝ}^{64 \times \frac{W}{f} \times \frac{H}{f}}$$

that is then used to condition the generative process performed by denoising model 245. Though embodiments of fine-level encoder 235 and coarse-level encoder 240 downsample the inputs by 32× and 8× (quarter resolution), respectively, embodiments are not necessarily limited thereto, and different embodiments may extract features at different downsampling ratios, such as 16×, 4×, or 2×.

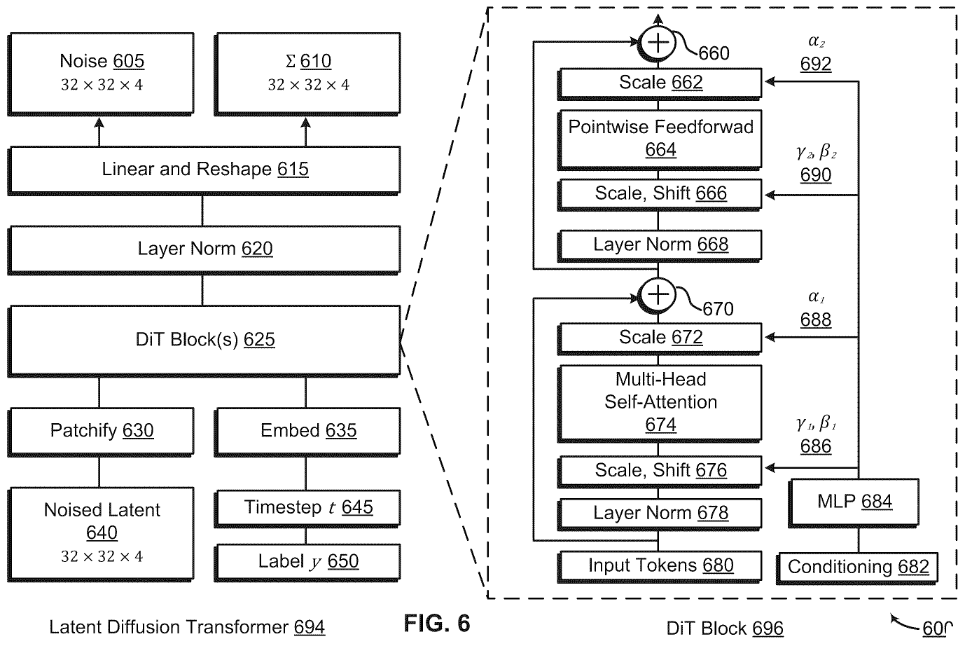

Denoising model 245 is a generative model used to process latent features to infer additional details. Embodiments of denoising model 245 include, for example, a guided latent diffusion model such as a U-Net-based model or a diffusion transformer (DiT)-based model. In the case of a DiT-based model, the denoising model 245 may tokenize Z_{combined}, a noise sample in the latent space Zₙₒᵢₛₑ, and combine these tokens with optional text tokens generated by text encoder 220 to obtain a set of tokens that are iteratively denoised. For example, denoising model 245 may tokenize inputs to obtain token_{Z}_{_{combined}}, token_{z}_{ₙₒᵢₛₑ} and token_{z}_{ₜₑₓₜ}. Then, through cross-attention operations, denoising model 245 processes token_{z}_{ₙₒᵢₛₑ} by incorporating information from token_{Z}_{_{combined}} and token_{z}_{ₜₑₓₜ} to generate token_{z}_{_{denoised}}, Denoising model 245 may then de-tokenize token_{z}_{_{denoised}} to obtain z_{denoised}, which can be decoded by decoder 250 to obtain the restored image. Additional detail regarding an example DiT is provided with reference to FIG. 6.

According to some aspects, denoising model 245 tokenizes the downsampled image and the latent image features to obtain a sequence of image tokens, where the restored image is generated based on the sequence of image tokens. In some examples, denoising model 245 obtains latent noise features. In some examples, denoising model 245 denoises the latent noise features based on the downsampled image and the latent image features to obtain latent denoised features. Denoising model 245 may additionally perform de-tokenization operations to obtain features in the input latent space.

Decoder 250 is configured to generate pixel images from latent representations. According to some aspects, denoising model 245 tokenizes input latent image features, denoises these tokens, and then de-tokenizes the processed tokens to obtain adjusted image features. Decoder 250 then processes the adjusted image features to obtain the restored image. Additional detail regarding an example of the decoder is provided with reference to FIG. 8.

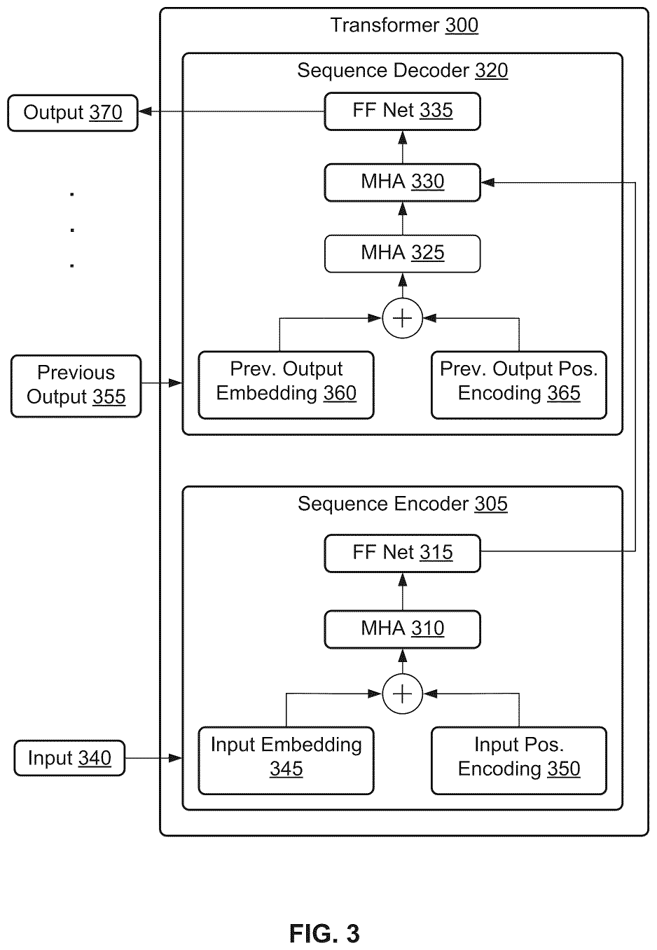

FIG. 3 shows an example of a transformer network according to aspects of the present disclosure. The example shown includes transformer 300, sequence encoder 305, sequence decoder 320, input 340, input embedding 345, input positional encoding 350, previous output 355, previous output embedding 360, previous output positional encoding 365, and output 370.

In some cases, sequence encoder 305 includes multi-head self-attention sublayer 310 and feed-forward network sublayer 315. In some cases, sequence decoder 320 includes first multi-head self-attention sublayer 325, second multi-head self-attention sublayer 330, and feed-forward network sublayer 335.

According to some aspects, a machine learning model (such as text encoder and the image generation model described with reference to FIG. 2) comprises transformer 300. In some cases, sequence encoder 305 is configured to map input 340 (for example, a query or a prompt comprising a sequence of words or tokens) to a sequence of continuous representations that are fed into sequence decoder 320. In some cases, sequence decoder 320 generates output 370 (e.g., a prediction of an output sequence of words or tokens) based on the output of sequence encoder 305 and previous output 355 (e.g., a previously predicted output sequence), which allows for the use of autoregression.

For example, in some cases, sequence encoder 305 parses input 340 into tokens and vectorizes the parsed tokens to obtain input embedding 345, and adds input positional encoding 350 (e.g., positional encoding vectors for input 340 of a same dimension as input embedding 345) to input embedding 345. In some cases, input positional encoding 350 includes information about relative positions of words or tokens in input 340.

In some cases, sequence encoder 305 comprises one or more encoding layers (e.g., six encoding layers) that generate contextualized token representations, where each representation corresponds to a token that combines information from other input tokens via self-attention mechanism. In some cases, each encoding layer of sequence encoder 305 comprises a multi-head self-attention sublayer (e.g., multi-head self-attention sublayer 310). In some cases, the multi-head self-attention sublayer implements a multi-head self-attention mechanism that receives different linearly projected versions of queries, keys, and values to produce outputs in parallel. In some cases, each encoding layer of sequence encoder 305 also includes a fully connected feed-forward network sublayer (e.g., feed-forward network sublayer 315) comprising two linear transformations surrounding a Rectified Linear Unit (ReLU) activation:

FFN(x)=ReLU(W₁x+b₁)W₂+b₂ (1)

In some cases, each layer employs different weight parameters (W₁, W₂) and different bias parameters (b₁, b₂) to apply a same linear transformation to each word or token in input 340. As described with reference to FIG. 2, a multimodal encoder may generate tokens interpretable by the transformer from data of different modalities, such as image data, sound data, and video data. A connector network may project these tokens into the same embedding space as other modalities, e.g., the tokens representing text.

In some cases, each sublayer of sequence encoder 305 is followed by a normalization layer that normalizes a sum computed between a sublayer input xand an output sublayer (x) generated by the sublayer:

layernorm(x+sublayer(x)) (2)

In some cases, sequence encoder 305 is bidirectional because sequence encoder 305 attends to each word or token in input 340 regardless of a position of the word or token in input 340.

In some cases, sequence decoder 320 comprises one or more decoding layers (e.g., six decoding layers). In some cases, each decoding layer comprises three sublayers including a first multi-head self-attention sublayer (e.g., first multi-head self-attention sublayer 325), a second multi-head self-attention sublayer (e.g., second multi-head self-attention sublayer 330), and a feed-forward network sublayer (e.g., feed-forward network sublayer 335). In some cases, each sublayer of sequence decoder 320 is followed by a normalization layer that normalizes a sum computed between a sublayer input x and an output sublayer (x) generated by the sublayer.

In some cases, sequence decoder 320 generates previous output embedding 360 of previous output 355 and adds previous output positional encoding 365 (e.g., position information for words or tokens in previous output 355) to previous output embedding 360. In some cases, each first multi-head self-attention sublayer receives the combination of previous output embedding 360 and previous output positional encoding 365 and applies a multi-head self-attention mechanism to the combination. In some cases, for each word in an input sequence, each first multi-head self-attention sublayer of sequence decoder 320 attends only to words preceding the word in the sequence, and so transformer 300's prediction for a word at a particular position only depends on known outputs for a word that came before the word in the sequence. For example, in some cases, each first multi-head self-attention sublayer implements multiple single-attention functions in parallel by introducing a mask over values produced by the scaled multiplication of matrices Q and K by suppressing matrix values that would otherwise correspond to disallowed connections.

In some cases, each second multi-head self-attention sublayer implements a multi-head self-attention mechanism similar to the multi-head self-attention mechanism implemented in each multi-head self-attention sublayer of sequence encoder 305 by receiving a query Q from a previous sublayer of sequence decoder 320 and a key K and a value V from the output of sequence encoder 305, allowing sequence decoder 320 to attend to each word in the input 340.

In some cases, each feed-forward network sublayer implements a fully connected feed-forward network similar to feed-forward network sublayer 315. In some cases, the feed-forward network sublayers are followed by a linear transformation and a softmax function to generate a prediction of output 370 (e.g., a prediction of a next word or token in a sequence of words or tokens). According to some aspects, this prediction of a next word or token is generated in the form of a probability distribution over a token vocabulary, and this probability distribution is used utilized directly by embodiments herein to compute a hallucination score and subsequently a hallucination label.

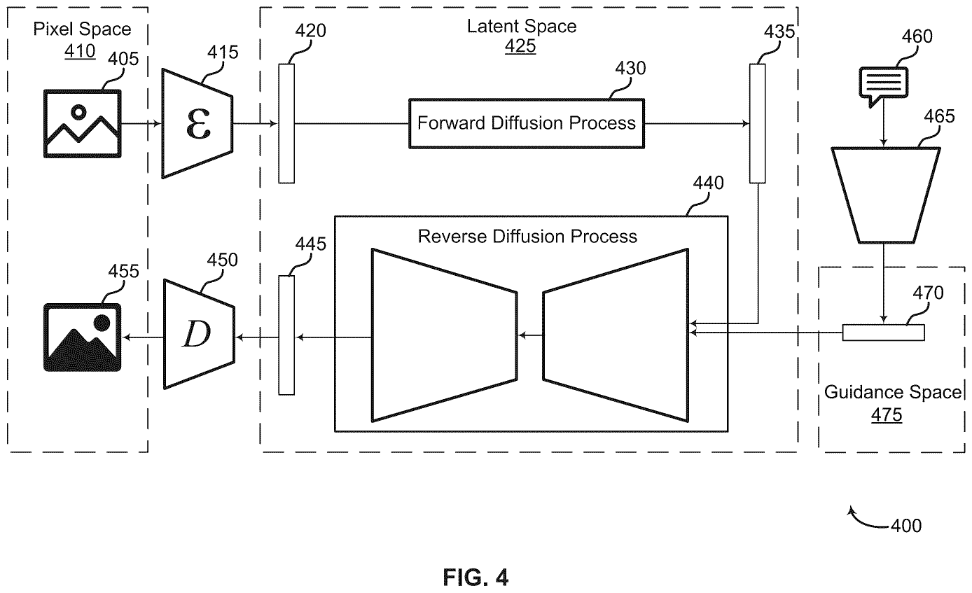

FIG. 4 shows an example of a guided latent diffusion model 400 according to aspects of the present disclosure. The guided latent diffusion model 400 depicted in FIG. 4 is an example of, or includes aspects of, the image generation model 225 described with reference to FIG. 2.

Diffusion models are a class of generative neural networks which can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance), image inpainting, and image manipulation.

Types of diffusion models include Denoising Diffusion Probabilistic Models (DDPMs) and Denoising Diffusion Implicit Models (DDIMs). In DDPMs, the generative process includes reversing a stochastic Markov diffusion process. DDIMs, on the other hand, use a deterministic process so that the same input results in the same output. Diffusion models may also be characterized by whether the noise is added to the image itself, or to image features generated by an encoder (i.e., latent diffusion).

Diffusion models work by iteratively adding noise to the data during a forward process and then learning to recover the data by denoising the data during a reverse process. For example, during training, guided latent diffusion model 400 may take an original image 405 in a pixel space 410 as input and apply and image encoder 415 to convert original image 405 into original image features 420 in a latent space 425. Then, a forward diffusion process 430 gradually adds noise to the original image features 420 to obtain noisy features 435 (also in latent space 425) at various noise levels.

Next, a reverse diffusion process 440 (e.g., a U-Net ANN or a DIT ANN) gradually removes the noise from the noisy features 435 at the various noise levels to obtain denoised image features 445 in latent space 425. In some examples, the denoised image features 445 are compared to the original image features 420 at each of the various noise levels, and parameters of the reverse diffusion process 440 of the diffusion model are updated based on the comparison. Finally, an image decoder 450 decodes the denoised image features 445 to obtain an output image 455 in pixel space 410. In some cases, an output image 455 is created at each of the various noise levels. The output image 455 can be compared to the original image 405 to train the reverse diffusion process 440.

In some cases, image encoder 415 and image decoder 450 are pre-trained prior to training the reverse diffusion process 440. In some examples, they are trained jointly, or the image encoder 415 and image decoder 450 and fine-tuned jointly with the reverse diffusion process 440.

The reverse diffusion process 440 can also be guided based on a text prompt 460, or another guidance prompt, such as an image, a layout, a segmentation map, etc. The text prompt 460 can be encoded using a text encoder 465 (e.g., a multimodal encoder) to obtain guidance features 470 in guidance space 475. The guidance features 470 can be combined with the noisy features 435 at one or more layers of the reverse diffusion process 440 to ensure that the output image 455 includes content described by the text prompt 460. For example, guidance features 470 can be combined with the noisy features 435 using a cross-attention block within the reverse diffusion process 440.

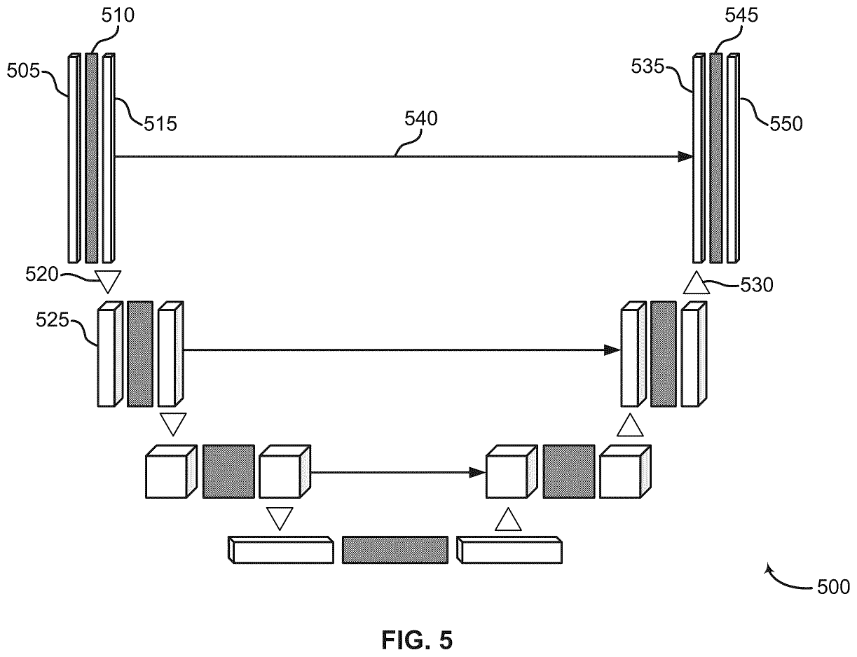

FIG. 5 shows an example of a U-Net architecture according to aspects of the present disclosure. In some examples, U-Net 500 is an example of the component that performs the reverse diffusion process 440 of guided diffusion model 400 described with reference to FIG. 4 and includes architectural elements of the image generation model 225 and the decoder 250 described with reference to FIG. 2. For example, the decoder 250 may be based on, e.g., the upsampling portion of the U-Net described herein. The U-Net 500 depicted in FIG. 5 is an example of, or includes aspects of, the architecture used within the reverse diffusion process described with reference to FIG. 4.

In some examples, diffusion models are based on a neural network architecture known as a U-Net. The U-Net 500 takes input features 505 having an initial resolution and an initial number of channels and processes the input features 505 using an initial neural network layer 510 (e.g., a convolutional network layer) to produce intermediate features 515. The intermediate features 515 are then down-sampled using a down-sampling layer 520 such that down-sampled features 525 have a resolution less than the initial resolution and a number of channels greater than the initial number of channels.

This process is repeated multiple times, and then the process is reversed. That is, the down-sampled features 525 are up-sampled using up-sampling process 530 to obtain up-sampled features 535. The up-sampled features 535 can be combined with intermediate features 515 having a same resolution and number of channels via a skip connection 540. These inputs are processed using a final neural network layer 545 to produce output features 550. In some cases, the output features 550 have the same resolution as the initial resolution and the same number of channels as the initial number of channels.

In some cases, U-Net 500 takes additional input features to produce conditionally generated output. For example, the additional input features could include a vector representation of an input prompt. The additional input features can be combined with the intermediate features 515 within the neural network at one or more layers. For example, a cross-attention module can be used to combine the additional input features and the intermediate features 515.

FIG. 6 shows an example of a diffusion transformer (DiT) architecture according to aspects of the present disclosure. While some generative diffusion models are based on a convolutional layer backbone (e.g., the U-Net), others may be based on a transformer network backbone. The DiT illustrated in FIG. 6 is a component of, or includes aspects of, the denoising model 245 described with reference to FIG. 2.

The example shown includes predicted noise 605, predicted covariance 610, linear and reshape layers 615, normalization layer 620, DiT block(s) 625, patchify operation 630, embedding 635, noised latent 640, timestep information 645, label information 650, and an implementation of one block in the DiT block(s) 625 by a DIT Block 696. The DiT Block 696 includes: second residual connection 660, second scaling operations 662, feed-forward network 664, post-normalization second scaling and shifting 666, second normalization 668, first residual connection 670, first scaling operations 672, self-attention 674, post-normalization first scaling and shifting 676, first normalization 678, input tokens 680, conditioning tokens 682, multi-layer perceptron (MLP) 684, post-normalization first scaling and shifting parameters 686, first scaling parameter 688, post-normalization second scaling and shifting parameters 690, and second scaling parameter 692. In some embodiments, the architecture uses a Latent Diffusion Transformer 694. In some embodiments, DiT Block 696 uses an “adaL N-Zero” technique.

Diffusion Transformers (DiTs) is a popular architecture for diffusion models and is designed to be structurally faithful to standard transformer architecture. DiT incorporates transformer structures' scaling properties. For training denoising diffusion probabilistic models (DDPMs) of images (e.g., spatial representations of images), DiT is based on a Vision Transformer (ViT) architecture which operates on sequences of patches. DiT processes images by dividing them into patches, converting these patches into tokens, and applying attention mechanisms to model relationships between different regions of the image. This approach allows the model to capture both local and long-range dependencies in the image generation process.

In some cases, input to DiT is a spatial representation z. For 256×256×3 images, z has shape 32×32×4. A first layer of a DIT is to carry out patchify operation, where the DiT divides an input image into patches and converts the patches (a form of spatial input) into a sequence of T tokens, each of dimension d, by linearly embedding each patch in the input. Following the patchify process, ViT frequency-based positional embeddings are applied to all input tokens. In some cases, the number of tokens T created by patchify is determined by a patch size hyperparameter p. In some cases, T=(I/p)², where I is another shape parameter, thus halving p will quadruple T, which in some cases at least quadruples total of transformer Giga Floating Point Operations (Gflops). Accordingly, embodiments herein can increase inference speed by configuring and operating within a highly compressed latent space, resulting in fewer processed tokens relative to higher spatial dimension (e.g., H×W) spaces. In some examples, changing p has no impact on downstream parameter counts, i.e., parameter counts in downstream layers of DiT is independent from p. In some examples, p=2, 4 or 8. Various patch sizes, transformer block architectures and model sizes are implemented.

Following Patchify operation, attention mechanisms are applied to model relationships between different regions of the image in one or more DiT blocks. In addition to noised image inputs, diffusion models sometimes process additional conditional information such as noise timesteps t, class labels c, natural language information, etc. Four variants of transformer blocks for processing conditional inputs including both input information and conditional information are described below.

In some cases, DiT blocks in the DiT network are implemented using adaptive layer norm (adaLN) blocks. Following adaptive normalization layers in generative adversarial networks (GANs) and conventional diffusion models with U-Net backbones, in some examples, standard normalization layers in transformer blocks are replaced with adaptive layer norm (adaL N). Rather than directly learning dimension-wise scale γ and shift parameters β, in adaL N the system regresses γ and β from a sum of the embedding vectors of the noise timesteps t and the class labels c. An adaLN adds relatively small numbers of Gflops and is more efficient. Additionally, adaL N is a conditioning mechanism that applies a same function to all tokens.

In some cases, DiT blocks in the DiT network are implemented using adaL N-Zero blocks, which leverages zero-initialization techniques. In Residual Networks (ResNets), initializing each residual block as the identity function x→x is beneficial. In some examples, zero-initializing a final batch norm scale factor γ in each block accelerates large-scale training in supervised learning settings. Diffusion models based on U-Nets use a similar initialization strategy, zero-initializing final convolutional layer in each block prior to residual connections. An adaLN-Zero block is modified from an adaLN block using similar zero-initialization techniques. In addition to regressing the dimension-wise scale γ and the shifting parameters β, the system also regresses dimension-wise scaling parameters as that are applied immediately prior to residual connections within the DiT block. The network initializes a multi-layer perceptron (MLP) to output a zero-vector for all as; this initializes an entire DiT block as the identity function. As with the adaLN block, adaL N Zero adds negligible Gflops to the model.

In some cases, DiT blocks in the DiT network are implemented using in-context conditioning, where vector embeddings of t and c are appended as two additional tokens in the input sequence, and after a final block, the network removes the two conditioning tokens from the sequence.

In some cases, DiT blocks in the DiT network include cross-attention blocks. The DiT network concatenates the embeddings of t and c into a length-two sequence, separate from the image token sequence. The transformer block is modified to include an additional multi-head cross-attention layer following the multi-head self-attention block.

In some cases, the DiT network includes a sequence of N DiT blocks, each operating at a hidden dimension size d. Following ViT, the DiT network uses standard transformer configs that jointly scale N, d and attention heads. In some examples, Small (S), Base (B), Large (L) variants, X Large (XL) variants of model sizes are implemented. Small or Base model sizes have N=12 layers of DiT blocks, Large model sizes have 24 layers of DiT blocks. X Large model sizes have 28 layers of DiT blocks.

After a final DiT block, the DiT network decodes the sequence of image tokens into an output noise prediction and an output diagonal covariance prediction. Both outputs have shape equal to an original spatial input. Standard linear decoder is utilized to decode, wherein a final normalization layer (or adaptive normalization layer if the DiT block is an adaL N block) and linearly decode each token into a p×p×2C tensor, where C is a number of channels in the spatial input to the DiT network and p is the patch size hyperparameter. Finally, decoded tokens are rearranged into their original spatial layout to get the predicted noise and covariance.

The architecture 600, in some cases, uses a Latent Diffusion Transformer 694. The architecture 600 processes noised latent 640, which may be a noised version of an input image encoded in a latent space. Patchify operation 630 divides the noised latent into a sequence of patches that are processed as tokens. The tokens are vector representations of each patch of the image in latent space and are adjusted through attention processes. Each of the tokens also receives timestep information 645 and label information 650 and, accordingly, their embedding 635, which encodes the current denoising timestep and class labels as conditional information. In some cases, embedding 635 is referred to as conditional embedding or conditional information embedding. In some cases, a positional embedding which encodes each token's spatial position in the image is applied to the patchified input tokens at the patchify operations 630. In some examples the positional embedding is ViT frequency-based positional embedding. The input tokens 680 generated by the patchify operation 630 and the conditioning tokens 682 generated by the embedding 635 are processed through N DiT block(s) 625, where N may be 62, 24 or 28. Other values of N may be used. In some cases, conditional tokens refer to tokens generated based on embedding 635 encoding timestep information 645 and label information 650.

Each of the DiT block(s) 625 includes multiple processing stages. DiT Block 696 illustrates an embodiment of one block in the DiT block(s) 625. In some embodiments, the DiT Block 696 is an example of, or includes aspects of, the adaL N-Zero block. In some cases, input tokens 680 interact with the conditioning tokens 682 through multiple attention mechanisms. Particularly, after first normalization 678 applied to the input tokens and MLP 684 to the conditional tokens, MLP 684 generates or updates post-normalization first scaling and shifting parameters 686, denoted as γ₁, β₁, for post-normalization first scaling and shifting 676 to scale and shift the output of first normalization 678 accordingly. As the normalized input tokens obtained from first normalization 678 are scaled and shifted at post-normalization first scaling and shifting 676 using the conditional information carried as least in γ₁, β₁, this allows the input information and conditional information to interact. Self-attention 674 allows the scaled and shifted normalized input tokens, namely the output from post-normalization first scaling and shifting 676, to attend to each other. MLP 684 also generates or updates first scaling parameter 688 denoted as α₁ for first scaling operations 672 to scale the output of self-attention 674 (e.g., multi-head self-attention), further interacting the input information and conditional information. The input tokens 680 is then summed with the output of first scaling operations 672 at first residual connection 670. In some examples, α₁ has initial values 0, and the DIT Block 696 is initialized as the identity function.

A similar process is performed in a second half of the DIT Block 696. MLP 684 generates or updates post-normalization second scaling and shifting parameters 690, denoted as γ₂, β₂, for post-normalization second scaling and shifting 666 to scale and shift the output of second normalization 668 accordingly. As the output from second normalization 668 is scaled and shifted using the conditional information carried at least in γ₂, β₂, this allows the input information and conditional information to further interact. Feed-forward network 664 then processes the scaled and shifted output from post-normalization second scaling and shifting 666. MLP 684 also generates or updates second scaling parameter 692 denoted as α₂ for second scaling operations 662 to scale the output of feed-forward network 664, further interacting the input information and conditional information. In some cases, the feed-forward network 664 is a pointwise feed-forward network. The output from first residual connection 670 is then summed with the output of second scaling operations 662 at second residual connection 660, and the result is the final output of DIT Block 696. In some examples, α₂ has initial values 0, and the DIT Block 696 is initialized as the identity function. This process repeats for each DiT block in the sequence.

After processing through all DiT block(s) 625, the outputs undergo normalization layer 620 followed by linear and reshape layers 615. The final output is the predicted noise 605, which represents the model's prediction of the noise that was added to initially create the noised latent 640, and the predicted covariance 610, which represents the model's prediction of the covariance. The predicted noise 605 is removed from noised latent 640 at each diffusion timestep, and the predicted covariance may affect how noise is removed or resampled in the reverse or denoising process. At the end of the denoising schedule, the latent sample is decoded to generate the synthetic image in pixel space.

FIG. 7 shows an example of a multi-level encoder according to aspects of the present disclosure. The example shown includes degraded image 700, downsampler 705, fine-level encoder 710, first latent maps 715, intermediate image 720, coarse-level encoder 725, second latent maps 730, downsampled image 735, concatenation 740, and multi-level input 745.

Downsampler 705 is an example of, or includes aspects of, the corresponding element described with reference to FIG. 2. Fine-level encoder 710 is an example of, or includes aspects of, the corresponding element described with reference to FIGS. 2 and 11. Intermediate image 720 is an example of, or includes aspects of, the corresponding element described with reference to FIG. 11. Coarse-level encoder 725 is an example of, or includes aspects of, the corresponding element described with reference to FIGS. 2 and 11.

Degraded image 700 is an example of, or includes aspects of, the corresponding element described with reference to FIGS. 1, 8, and 9. Downsampled image 735 is an example of, or includes aspects of, the corresponding element described with reference to FIG. 11. Multi-level input 745 is an example of, or includes aspects of, the corresponding element described with reference to FIGS. 8, 9, and 11.

Embodiments may enable operation of billion-scale Diffusion Transformer (DIT) models at 1K resolution and beyond by prioritizing optimizing latent channel capacity and deepening the latent space mapping through via downsampling layers. This approach reduces token count, which helps address the computational demands associated with the self-attention mechanisms in DiT architectures. As spatial compression increases, the spatial resolution of the latent representation becomes smaller, which may necessitate a corresponding increase in latent channel count to help preserve information fidelity. For an input image I ∈ [symbol] the multi-level encoder (sometimes referred to herein as a “pyramid encoder”) maps it to a latent code

$$z ∈ {ℝ}^{C \times \frac{H}{f} \times \frac{W}{f}} ,$$

where f is a spatial compression ratio. Although increasing latent channels can help maintain information, higher compression ratios may still affect reconstruction quality in certain cases.

According to some aspects, the architecture employs a three-level pyramid VAE encoder to capture different aspects of the image information. This structure may include fine-level encoding for high-frequency image details; coarse-level features for lower-resolution structural elements; and macro-level semantics for broader contextual information. These cascaded latent codes together form a highly compressed image representation. FIG. 7 illustrates this pyramid latent structure.

In some embodiments, the fine-level and coarse-level encoders independently encode representations from different image resolutions. Fine-level encoder 710 may operate on the original degraded image 700 without downsampling, producing first latent maps 715 comprising a 52-channel latent encoding

$${𝓏}_{fine} ∈ {ℝ}^{52 \times \frac{H}{f} \times \frac{W}{f}} .$$

For example, for spatial compression ratio f=32, the number of latent channels in z_{fine} fine may be 52. The coarse-level encoder 725 captures lower-resolution features by processing intermediate image 720, which represents a 4× downsampled version of the input I_{⬇4} resulting in second latent maps 730 comprising a 9-channel latent encoding

$${𝓏}_{coarse} ∈ {ℝ}^{9 \times \frac{H}{f} \times \frac{W}{f}} .$$

According to some aspects, the system incorporates macro-level semantics through downsampled image 735, which represents a 32× downsampled version of the input I_{⬇4} and is treated as a 3-channel image. This downsampled image may be used directly, or in some embodiments, a macro-level representation is calculated using the downsampled image along with statistical parameters derived from the training dataset, such as mean u and standard deviation values σ, e.g. as

$${z}_{macro} = \frac{{I}_{↓ 32} - μ}{σ} .$$

The multi-level input 745

$$( e . g . {z}_{combined} ∈ {ℝ}^{64 \times \frac{W}{f} \times \frac{H}{f}} )$$

is formed through concatenation 740, which combines the latent codes across all levels to create a final highly-compressed 64-channel representation. This combined representation serves as input to subsequent processing stages, which provides a comprehensive encoding that preserves information at multiple scales while maintaining computational efficiency. While FIG. 7 illustrates an example of a compression ratio f=32 resulting in a latent depth dimension of 64 for multi-level input 745, embodiments are not necessarily limited thereto, and other embodiments may use different spatial compressions and scales that may result in different numbers of depth channels.

FIG. 8 shows an example of a decoder according to aspects of the present disclosure. The example shown includes degraded image 800, degradation-aware feature extractor 805, multi-level input 810, pixel-aware decoder 815, skip connection 820, and restored image 825.

Degraded image 800 is an example of, or includes aspects of, the corresponding element described with reference to FIGS. 1, 7, and 9. Multi-level input 810 is an example of, or includes aspects of, the corresponding element described with reference to FIGS. 7, 9, and 11. Restored image 825 is an example of, or includes aspects of, the corresponding element described with reference to FIGS. 1 and 9.

In some embodiments, the decoder illustrated in FIG. 8 processes information from both the highly compressed latent representation and the original input image to produce a restored image. The multi-level input 810, which contains the compressed representation generated by the multi-level encoder described with reference to FIG. 7, is input to the pixel-aware decoder 815.

According to some aspects, the degradation-aware feature extractor 805 processes the degraded image 800 to extract spatial features at multiple scales. These features may capture pixel-level details that complement the information contained in the multi-level input 810. The degradation-aware feature extractor 805 may be designed to effectively process images with various types of degradation, such as blur, noise, or compression artifacts.

The pixel-aware decoder 815 receives the multi-level input 810 and progressively upsamples it to reconstruct a high-resolution image. During this process, skip connection 820 transfers the multi-scale spatial information from the degradation-aware feature extractor 805 to the pixel-aware decoder 815. These connections may help incorporate pixel-level details from the degraded image into the reconstruction process, which enhances fidelity and detail quality in the restored image 825.

In some embodiments, the pixel-aware decoder 815 includes additional residual layers positioned between upsampling blocks to effectively integrate the spatial information provided through skip connection 820. This architecture enables the decoder to leverage information from both the compressed latent representation and the original input image, which may improve reconstruction accuracy for image processing and restoration tasks that require high pixel fidelity.

During training, the system may freeze the multi-level encoder while allowing the degradation-aware feature extractor 805 and pixel-aware decoder 815 to be updated. This approach enables the decoder to learn how to effectively combine information from the compressed latent representation with pixel-level details from the degraded input image. The training process may use image reconstruction as its objective, and it can be performed after training other components of the system to enhance output quality.

### Restoring and Upsampling Images

FIG. 9 shows an example of an inference pipeline according to aspects of the present disclosure. The example shown includes degraded image 900, multi-level encoder 905, multi-level input 910, noise sample 915, patch embedder networks 920, image tokens 925, text input 930, text encoder 935, text tokens 940, denoising model 945, denoised tokens 950, decoder 955, and restored image 960. The pipeline may be used to restore degraded images or to supersample low resolution images.

Degraded image 900 is an example of, or includes aspects of, the corresponding element described with reference to FIGS. 1, 7, and 8. Multi-level input 910 is an example of, or includes aspects of, the corresponding element described with reference to FIGS. 7, 8, and 11. Restored image 960 is an example of, or includes aspects of, the corresponding element described with reference to FIG. 1.

Text encoder 935 is an example of, or includes aspects of, the corresponding element described with reference to FIG. 2. Denoising model 945 is an example of, or includes aspects of, the corresponding element described with reference to FIG. 2. Decoder 955 is an example of, or includes aspects of, the corresponding element described with reference to FIGS. 2 and 11.

In some embodiments, the inference pipeline illustrated in FIG. 9 processes a degraded image to produce a high-quality restored image. The process begins with degraded image 900, which may be a low-resolution or otherwise impaired image that requires restoration. This degraded image serves as input to multi-level encoder 905, which compresses the image into a latent representation following the multi-level encoding approach described with reference to FIG. 7.

The multi-level encoder 905 produces multi-level input 910, which represents a highly compressed version of the degraded image in latent space. According to some aspects, this compressed representation maintains important structural and semantic information while significantly reducing spatial dimensions. The system may also generate noise sample 915, which is used as a starting point for the denoising process.

Patch embedder networks 920 process both the multi-level input 910 and noise sample 915 to generate image tokens 925. In some embodiments, separate parameter-independent patch embedder networks are used for each input type to account for their different characteristics, despite residing in the same latent space. These tokenized representations may be arranged sequentially for further processing.

The pipeline may additionally incorporate text input 930, which provides semantic guidance for the restoration process. Text encoder 935 processes this input to generate text tokens 940, which contain contextual information that can help refine degraded regions in the image. In some embodiments, text input 930 is not provided, and the system operates with only image-based conditioning.

Denoising model 945 receives and processes the combination of image tokens 925 and text tokens 940. This model may implement a diffusion transformer architecture as described with reference to earlier figures. Through a series of denoising steps, the model progressively refines the noisy representation to generate a high-quality output, denoised tokens 950. During this process, cross-attention mechanisms may allow the model to incorporate information from the degraded image and text guidance into the denoising process. The denoised tokens 950 may be a transformation of image tokens 925; e.g., the text tokens 940 be discarded after the denoising process is complete.

The denoised tokens 950 may be detokenized back into the latent space to be processed by decoder 955, which may implement the pixel-aware decoding approach described with reference to FIG. 8. This decoder upsamples the denoised latent representation and may incorporate additional details from the original degraded image through skip connections. The final output is restored image 960, which depicts the elements from degraded input in high-quality and in a high-resolution format.

Accordingly, embodiments herein are configured to restore degraded images or to supersample low resolution images. The system can address a variety of image degradation types including blurring, noise, JPEG compression artifacts, and significant downsampling. In some embodiments, the pipeline may function as a high-factor upsampler, capable of performing super-resolution from severely downsampled inputs (e.g., 16× or 20× downsampled) to high-resolution outputs. For example, embodiments may process a low resolution by upscaling it to the desired resolution and then putting this upscaled image through the pipeline. Some embodiments may perform data augmentations on this input such as adding gaussian blur in the target resolution before processing.

FIG. 10 shows an example of a method 1000 for generating a restored image according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 1005, the system obtains an input image including a degradation artifact. Degradation artifacts may include blur, noise, compression artifacts (such as those from JPEG encoding), low resolution, or a combination of multiple impairments. The system may receive this input image from various sources including a camera, a storage device, or over a network connection. In some embodiments, the input image may be manually identified by a user as requiring restoration. In some cases, the operations of this step refer to, or may be performed by, an image processing apparatus as described with reference to FIG. 1.

At operation 1010, the system downsamples the input image to obtain a downsampled image. This downsampling process may reduce the spatial dimensions of the input image by a predetermined factor (such as 4× or 32×) to create representations at multiple scales. In some embodiments, this operation facilitates efficient processing by reducing computational requirements while preserving important structural information. The downsampling may be performed using various techniques such as bicubic interpolation, average pooling, or learned downsampling operations. In some cases, the operations of this step refer to, or may be performed by, an image generation model as described with reference to FIG. 2.

At operation 1015, the system encodes the input image to obtain latent image features. The encoding process may include extracting multi-level features from the original input image and its downsampled versions, thereby representing details at different scales in a shared, highly-compressed latent space. The system uses a multi-level encoder architecture that produces a compressed latent representation containing information about fine details, coarse structures, and macro-level semantics. The latent image features represent the input image in a highly compressed form while preserving essential information for restoration. In some cases, the operations of this step refer to, or may be performed by, a fine-level encoder as described with reference to FIGS. 2, 7, and 11.

At operation 1020, the system generates a restored image based on the downsampled image and the latent image features where the restored image removes the degradation artifact from the input image. This generation process may involve a denoising model that progressively refines a noisy representation guided by the encoded features from the input image. In some embodiments, the system may incorporate additional inputs such as text prompts to provide semantic guidance for the restoration process. The system may use a decoder architecture that incorporates pixel-level details from the original input through skip connections to enhance the quality of the restored output. The resulting restored image has improved visual quality with reduced or eliminated degradation artifacts while maintaining fidelity to the content of the original input. In some cases, the operations of this step refer to, or may be performed by, an image generation model as described with reference to FIG. 2.

### Training Methods

FIG. 11 shows an example of a training pipeline according to aspects of the present disclosure. The example shown includes original image 1100, intermediate image 1105, downsampled image 1110, fine-level encoder 1115, coarse-level encoder 1120, intermediate decoder 1125, multi-level input 1130, and decoder 1135.

Intermediate image 1105 is an example of, or includes aspects of, the corresponding element described with reference to FIG. 7. Downsampled image 1110 is an example of, or includes aspects of, the corresponding element described with reference to FIG. 7. Multi-level input 1130 is an example of, or includes aspects of, the corresponding element described with reference to FIGS. 7-9.

Fine-level encoder 1115 is an example of, or includes aspects of, the corresponding element described with reference to FIGS. 2 and 7. Coarse-level encoder 1120 is an example of, or includes aspects of, the corresponding element described with reference to FIGS. 2 and 7. Decoder 1135 is an example of, or includes aspects of, the corresponding element described with reference to FIGS. 2 and 9.

In some embodiments, the training pipeline illustrated in FIG. 11 implements a progressive approach to train the components of the multi-level encoder and decoder. The process begins with original image 1100, which may be processed to create intermediate image 1105 (a 4× downsampled version) and downsampled image 1110 (a further downsampled version, such as 32×). These multi-scale representations are used as inputs to different parts of the encoding system.

The training process may occur in multiple phases. In a first training phase, coarse-level encoder 1120 and intermediate decoder 1125 may be trained together in a typical autoencoder fashion, where the encoder is trained to generate a latent representation, and the decoder is trained to interpret this latent representation to reproduce the input to the encoder. This phase configures the parameters of these networks to encode and decode lower-resolution image features. The coarse-level encoder 1120 processes intermediate image 1105 to generate a portion of the latent representation that captures coarse-level features.

After completing the first training phase, intermediate decoder 1125 may be discarded, while coarse-level encoder 1120 is retained for its role in generating part of the multi-level input 1130. In some embodiments, a second training phase then begins, which trains both fine-level encoder 1115 and decoder 1135 while keeping the parameters of coarse-level encoder 1120 frozen. This progressive approach allows the system to build upon the previously learned representations while optimizing the performance of the entire pipeline.

During the second training phase, fine-level encoder 1115 processes original image 1100 to extract high-frequency details. The outputs from fine-level encoder 1115, coarse-level encoder 1120, and features derived from downsampled image 1110 are combined to form multi-level input 1130, a highly compressed representation containing information across multiple scales. Decoder 1135 then attempts to reconstruct the original image from this multi-level input.

The training signal for optimizing the networks may be obtained by comparing the output of decoder 1135 against original image 1100. In some embodiments, this comparison utilizes a combination of discriminator loss and perceptual metrics such as LPIPS loss. According to some aspects, the entire encoding and decoding architecture may be implemented as a pure convolutional network without attention layers, which can reduce computational overhead while maintaining performance. For example, the attention layers may be used in only the denoising model as described with reference to FIGS. 6 and 9.

In some embodiments, the system may also train a diffusion transformer model for high-resolution image restoration using the latent space established by the multi-level encoder. This training may use synthetic data with various degradation patterns similar to those found in real-world scenarios. By operating in the highly compressed latent space (e.g., a 64×64 latent map for a 2048×2048 original image), the system can effectively process high-resolution images while maintaining computational efficiency. During this training, crop patches of various sizes may be used to enhance the model's generalization capabilities across different image resolutions and degradation types.

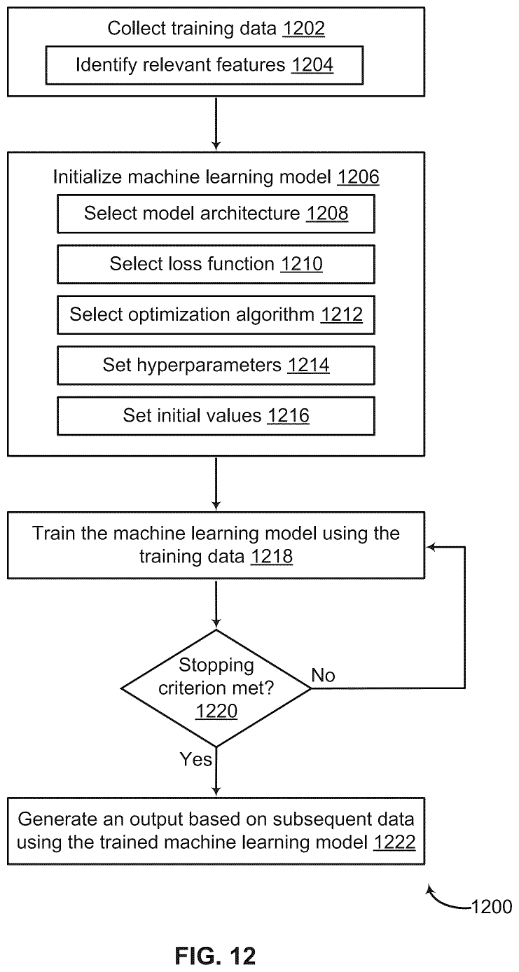

FIG. 12 is a flow diagram depicting an algorithm as a step-by-step procedure 1200 in an example implementation of operations performable for training a machine-learning model. The procedure 1200 provides one or more examples of generating training data, use of the training data to train a machine-learning model, and use of the trained machine-learning model to perform a task.

To begin in this example, a machine-learning system collects training data (block 1202) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1204) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 1206). Initialization of the machine-learning model includes selecting a model architecture (block 1208) to be trained. Examples of model architectures include neural networks, convolutional neural networks (CNNs), long short-term memory (LSTM) neural networks, transformer networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1210). The loss function is utilized to measure a difference between an output of the machine-learning model (i.e., predictions) and target values (e.g., as expressed by the training data) to be used to train the machine-learning model. Additionally, an optimization algorithm is selected (1212) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 1214) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 1218) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 1220), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1220), the procedure 1200 continues training of the machine-learning model using the training data (block 1218) in this example.

If the stopping criterion is met (“yes” from decision block 1220), the trained machine-learning model is then utilized to generate an output based on subsequent data (block 1222). The trained machine-learning model, for instance, is trained to perform a task as described above and therefore, once trained is configured to perform that task based on subsequent data received as an input and processed by the machine-learning model.

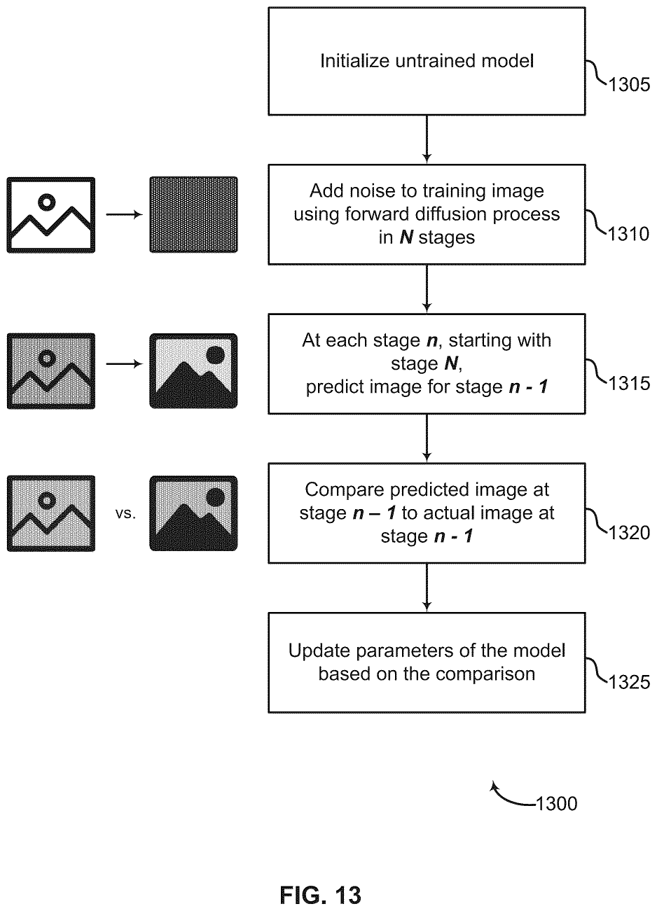

FIG. 13 shows an example of a method 1300 for training a diffusion model according to aspects of the present disclosure. In some embodiments, the method 1300 describes an operation for configuring the image generation model 225 as described with reference to FIG. 2. In some examples, these operations are performed by a system including a processor executing a set of codes to control functional elements of an apparatus, such as the guided diffusion model described in FIG. 4.

Additionally or alternatively, certain processes of method 1300 may be performed using special-purpose hardware. Generally, these operations are performed according to the methods and processes described in accordance with aspects of the present disclosure. In some cases, the operations described herein are composed of various substeps or are performed in conjunction with other operations.

At operation 1305, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 1310, the system adds noise to a training image using a forward diffusion process in N stages. In some cases, the forward diffusion process is a fixed process where Gaussian noise is successively added to an image. In latent diffusion models, the Gaussian noise may be successively added to features in a latent space.

At operation 1315, the system at each stage n, starting with stage N, a reverse diffusion process is used to predict the image or image features at stage n−1. For example, the reverse diffusion process can predict the noise that was added by the forward diffusion process, and the predicted noise can be removed from the image to obtain the predicted image. In some cases, an original image is predicted at each stage of the training process.

At operation 1320, the system compares predicted image (or image features) at stage n−1 to an actual image (or image features), such as the image at stage n−1 or the original input image. For example, given observed data x, the diffusion model may be trained to minimize the variational upper bound of the negative log-likelihood-log pe (x) of the training data.

At operation 1325, the system updates parameters of the model based on the comparison. For example, parameters of a U-Net or a DiT may be updated using gradient descent. Time-dependent parameters of the Gaussian transitions can also be learned.

FIG. 14 shows an example of a computing device 1400 according to aspects of the present disclosure. The example shown includes computing device 1400, processor(s) 1405, memory subsystem 1410, communication interface 1415, I/O interface 1420, user interface component(s), and channel 1430.

In some embodiments, computing device 1400 is an example of, or includes aspects of, an image processing apparatus as described in FIGS. 1 and 2. In some embodiments, computing device 1400 includes one or more processors 1405 are configured to execute instructions stored in memory subsystem 1410 to obtain an input image including a degradation artifact; downsample the input image to obtain a downsampled image; encode, using an image generation model, the input image to obtain latent image features; and generate, using the image generation model, a restored image based on the downsampled image and the latent image features wherein the restored image removes the degradation artifact from the input image.

According to some aspects, computing device 1400 includes one or more processors 1405. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1410 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. The memory may store various parameters of machine learning models used in the components described with reference to FIG. 2. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1415 operates at a boundary between communicating entities (such as computing device 1400, one or more user devices, a cloud, and one or more databases) and channel 1430 and can record and process communications. In some cases, communication interface 1415 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1420 is controlled by an I/O controller to manage input and output signals for computing device 1400. In some cases, I/O interface 1420 manages peripherals not integrated into computing device 1400. In some cases, I/O interface 1420 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating systems. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1420 or via hardware components controlled by the I/O controller.

According to some aspects, user interface component(s) 1425 enable a user to interact with computing device 1400. In some cases, user interface component(s) 1425 include an audio device, such as an external speaker system, an external display device such as a display screen, an input device (e.g., a remote-control device interfaced with a user interface directly or through the I/O controller), or a combination thereof. In some cases, user interface component(s) 1425 include a GUI.

Accordingly, the present disclosure includes the following aspects.

A method for image restoration is described. One or more aspects of the method include obtaining an input image including a degradation artifact; downsampling the input image to obtain a downsampled image; encoding, using an image generation model, the input image to obtain latent image features; and generating, using the image generation model, a restored image based on the downsampled image and the latent image features wherein the restored image removes the degradation artifact from the input image.

Some examples of the method, apparatus, non-transitory computer readable medium, and system further include downsampling the input image to obtain an intermediate image, wherein the intermediate image has a resolution between the input image and the downsampled image. Some examples further include encoding, using the image generation model, the intermediate image to obtain latent intermediate features, wherein the restored image is generated based on the latent intermediate features.

Some examples of the method, apparatus, non-transitory computer readable medium, and system further include concatenating the latent image features with pixel-space features from the downsampled image to obtain multi-scale image features, wherein the restored image is generated based on the multi-scale image features. Some examples further include tokenizing the downsampled image and the latent image features to obtain a sequence of image tokens, wherein the restored image is generated based on the sequence of image tokens.

Some examples of the method, apparatus, non-transitory computer readable medium, and system further include obtaining latent noise features. Some examples further include denoising the latent noise features based on the downsampled image and the latent image features to obtain latent denoised features. Some examples further include decoding the latent denoised features based on the input image to obtain the restored image. In some aspects, the image generation model is trained to perform image restoration based on a multi-scale input.

A method for image restoration is described. One or more aspects of the method include obtaining an input image; downsampling the input image to obtain an intermediate image having a resolution less than the input image; downsampling the input image to obtain a downsampled image having a resolution less than the intermediate image; and generating, using an image generation model, a restored image based on the input image, the intermediate image, and the downsampled image.

Some examples of the method, apparatus, non-transitory computer readable medium, and system further include encoding, using the image generation model, the input image to obtain latent image features. Some examples further include encoding, using the image generation model, the intermediate image to obtain latent intermediate features, wherein the restored image is generated based on the latent image features and the latent intermediate features.

Some examples of the method, apparatus, non-transitory computer readable medium, and system further include concatenating the latent image features with the latent intermediate features and with pixel-space features from the downsampled image to obtain multi-scale image features, wherein the restored image is generated based on the multi-scale image features. Some examples further include tokenizing the downsampled image, the latent image features, and the latent intermediate features to obtain a sequence of image tokens, wherein the restored image is generated based on the sequence of image tokens.

Some examples of the method, apparatus, non-transitory computer readable medium, and system further include obtaining latent noise features. Some examples further include denoising the latent noise features based on the intermediate image and the downsampled image to obtain latent denoised features. Some examples further include decoding the latent denoised features based on the input image to obtain the restored image. In some aspects, the image generation model is trained to perform image restoration based on a multi-scale input.

An apparatus for image restoration is described. One or more aspects of the apparatus include a memory component; a processing device coupled to the memory component, the processing device configured to perform operations comprising; obtaining a low quality image for image restoration; downsampling the low quality image to obtain a downsampled image in pixel space; encoding the low quality image to obtain a latent map in a latent space; and generating, using an image generation model, a restored image based on the low quality image, the downsampled image, and the latent map.

In some aspects, the image generation model comprises a diffusion transformer (DiT) model. In some aspects, the image generation model comprises a fine-level encoder configured to encode the input image to generate latent image features. In some aspects, the image generation model comprises coarse-level encoder configured to encode an intermediate image to generate latent intermediate features.

In some aspects, the image generation model comprises a decoder configured to decode latent image features. In some aspects, the image generation model is trained to perform image restoration based on a multi-scale input.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or Y Z or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining an input image including a degradation artifact;
downsampling the input image to obtain a downsampled image;
encoding, using an image generation model, the input image to obtain latent image features; and
generating, using the image generation model, a restored image based on the downsampled image and the latent image features wherein the restored image removes the degradation artifact from the input image.

2. The method of claim 1, further comprising:
downsampling the input image to obtain an intermediate image, wherein the intermediate image has a resolution between the input image and the downsampled image; and
encoding, using the image generation model, the intermediate image to obtain latent intermediate features, wherein the restored image is generated based on the latent intermediate features.

3. The method of claim 1, further comprising:
concatenating the latent image features with pixel-space features from the downsampled image to obtain multi-scale image features, wherein the restored image is generated based on the multi-scale image features.

4. The method of claim 1, wherein generating the restored image comprises:
tokenizing the downsampled image and the latent image features to obtain a sequence of image tokens, wherein the restored image is generated based on the sequence of image tokens.

5. The method of claim 1, wherein generating the restored image comprises:
obtaining latent noise features; and
denoising the latent noise features based on the downsampled image and the latent image features to obtain latent denoised features.

6. The method of claim 5, wherein generating the restored image comprises:
decoding the latent denoised features based on the input image to obtain the restored image.

7. The method of claim 1, wherein:
the image generation model is trained to perform image restoration based on a multi-scale input.

8. A non-transitory computer readable medium storing code, the code comprising instructions that, when executed by at least one processor, cause the at least one processor to perform operations comprising:
obtaining an input image;
downsampling the input image to obtain an intermediate image having a resolution less than the input image;
downsampling the input image to obtain a downsampled image having a resolution less than the intermediate image; and
generating, using an image generation model, a restored image based on the input image, the intermediate image, and the downsampled image.

9. The non-transitory computer readable medium of claim 8, the code further comprising instructions that, when executed by the at least one processor, cause the at least one processor to perform operations comprising:
encoding, using the image generation model, the input image to obtain latent image features; and
encoding, using the image generation model, the intermediate image to obtain latent intermediate features, wherein the restored image is generated based on the latent image features and the latent intermediate features.

10. The non-transitory computer readable medium of claim 9, the code further comprising instructions that, when executed by the at least one processor, cause the at least one processor to perform operations comprising:
concatenating the latent image features with the latent intermediate features and with pixel-space features from the downsampled image to obtain multi-scale image features, wherein the restored image is generated based on the multi-scale image features.

11. The non-transitory computer readable medium of claim 9, the code further comprising instructions that, when executed by the at least one processor, cause the at least one processor to perform operations comprising:
tokenizing the downsampled image, the latent image features, and the latent intermediate features to obtain a sequence of image tokens, wherein the restored image is generated based on the sequence of image tokens.

12. The non-transitory computer readable medium of claim 8, wherein generating the restored image comprises:
obtaining latent noise features; and
denoising the latent noise features based on the intermediate image and the downsampled image to obtain latent denoised features.

13. The non-transitory computer readable medium of claim 12, wherein generating the restored image comprises:
decoding the latent denoised features based on the input image to obtain the restored image.

14. The non-transitory computer readable medium of claim 8, wherein:
the image generation model is trained to perform image restoration based on a multi-scale input.

15. A system for image processing, comprising:
a memory component;
a processing device coupled to the memory component, the processing device configured to perform operations comprising:
obtaining a low quality image for image restoration;
downsampling the low quality image to obtain a downsampled image in pixel space;
encoding the low quality image to obtain a latent map in a latent space; and
generating, using an image generation model, a restored image based on the low quality image, the downsampled image, and the latent map.

16. The system of claim 15, wherein:
the image generation model comprises a diffusion transformer (DiT) model.

17. The system of claim 15, wherein:
the image generation model comprises a fine-level encoder configured to encode the low quality image to generate latent image features.

18. The system of claim 15, wherein:
the image generation model comprises coarse-level encoder configured to encode an intermediate image to generate latent intermediate features.

19. The system of claim 15, wherein:
the image generation model comprises a decoder configured to decode latent image features.

20. The system of claim 15, wherein:
the image generation model is trained to perform image restoration based on a multi-scale input.
